(19) United States
(12) Patent Application Publication
(10) Pub. No.: US 2002/0073418 A1
(43) Pub. Date: Jun. 13, 2002

(54) Method for transmitting interactive data

(76) Inventors: Etienne Grange, Paris (FR); Jerome Chouraqui, Paris (FR); Laurent Chouraqui, Paris (FR)

Correspondence Address: Schnader Harrison Segal & Lewis LLP, Suite 3600, 1600 Market Street, Philadelphia, PA, 19103, US

(21) Appl. No.: 10/010,179

(22) Filed: Nov. 13, 2001

Related U.S. Application Data
(63) Continuation of application No. PCT/FR00/01400, filed on May 22, 2000.

(30) Foreign Application Priority Data
May 21, 1999 (FR) 99/06529

(51) Int. Cl. H04N 7/16; H04H 9/00; H04N 7/025; H04N 7/10

(52) U.S. Cl. 725/22; 725/32; 725/36

(57) ABSTRACT

The invention concerns a device for long-distance transmission of a television program on a single channel and a process including transmitting a first video signal corresponding to a main program comprising advertising video images interposed between video broadcasts, and a second video signal corresponding to an optional advertising program and including a sequence triggering the recording in a temporary rapid storage, recording in a temporary rapid storage the second signal when the triggering sequence is detected and continuously transmitting the first signal to a display circuit. The first signal includes graphic signaling means for activating the restitution of the video signals stored in said memory.

### RELATED APPLICATION

This is a continuation of International Application No. PCT/FR00/01400, with an international filing date of May 22, 2000, which is based on French Patent Application No. 99/06529, filed May 21, 1999.

### FIELD OF THE INVENTION

This invention relates to the field of television programs, more particularly, programs offering interactivity with the viewer.

### BACKGROUND

Advertising as it is used on television channels is constituted by a sequence of short-films (or adverts) extolling one product or another. This sequencing does not allow the viewer to act directly on the provided information.

A first solution has consisted in displaying continuously, or at the end of the advert, a telephone call number, which the viewer can use to contact the advertiser directly. This method has the major drawback of being perceived as an act of purchase even when the aim is simply to obtain additional information.

Another solution consists of changing the actual format of the advertisement and converting it into a proper program extolling the merits of the product. In this case, the advertiser facilitates direct purchase of the product by providing ceaseless reminders that it is possible to buy it now.

These two kinds of advertising nevertheless leave the viewer in a passive state in front of the images received. Accordingly, it would be advantageous to overcome these difficulties by offering alternative forms of advertising.

WO 9830025 describes a system which allows the viewer to choose between several programs in a given sequence by multiplexing the different programs with the main channel. The viewer can then choose which advertising he or she wishes to view, or in a variant, which script a given advertisement will follow.

Also, WO 9853611 discloses a television transmitter, which transmits data in the form of Web pages simultaneously with the television signal. The transmission also includes the use of triggering data allowing the Web pages to be called in synchronization with the program. The triggering data includes (or refers back to) a perceptible signal, for example, a pictogram or a sound signal. In response to receipt of a triggering datum, a receiver reproduces the perceptible signal without appreciably modifying the television screen. The user is then alerted in a timely way to the presence of additional information relating to the television program being watched. The viewer can then decide whether or not to call the relevant web page. To inform the public in advance about broadcast triggering data and to facilitate access to Web pages at a previous or subsequent stage, the transmission also includes a table of contents allowing the triggering data transmitted during the program to be identified. The table of contents can itself be called by a triggering datum.

WO 9800975 concerns a system and a process allowing magnetic photographs associated with a video content to be displayed in an interactive television broadcasting system. That system and process can also be used to simulate an Internet home page on an interactive television broadcasting system. The system thus confers hyperlink web type browsing functions on an interactive television system. In accordance with the process, the video transmission system provides or broadcasts one or more video channels, each channel having a video content. The system also provides or broadcasts at least one magnetic photo broadcasting channel including several photos, preferably compressed photos in the MPEG-2 format. The user or viewer can select from the options displayed on the television screen to view required data. When the system decoder box receives an input from a user who has selected an option to view a photo in the magnetic photo stream, the decoder box captures the photo corresponding to the selection from the magnetic photo broadcasting channel, stores the photo in its memory and displays it. The user may also request to view magnetic photos not transmitted by the video transmission system at the time of request, in which case the system provides “to order” the photos requested by the user, by using a specialized “search” channel. The user may thus browse selectively between the video content and the magnetic photos as would be done with hyperlink web browsing functions.

### SUMMARY OF THE INVENTION

This invention relates to a process of remote transmission of a televised program on a single channel including transmitting a first video signal corresponding to a main program including video advertising slots interpolated between video slots, and a second video signal corresponding to an optional advertising program and including a sequence triggering recording in a temporary high-speed memory, recording the second signal in a temporary high-speed memory upon detection of said triggering sequence and substantially continuously transmitting the first signal to a display circuit, wherein the first signal includes graphic signaling means for activating retrieval of the video signals stored in the memory and the second signal is loaded in the memory upon receive initialization.

The invention also relates to an interface for program retrieval including interactive advertising sequences, a high-speed local memory connected to a demultiplexer, high-speed memory content display means and means for triggering the high-speed memory content display.

### DETAILED DESCRIPTION

The invention will be described in more detail with respect to advertisements. However, its scope extends to any transmission of visual or graphic elements by a communication means.

The invention concerns a remote transmission process of a televised program on a single channel. This process consists of transmitting a first video signal corresponding to a main program comprising video advertising slots interpolated between video slots, and a second video signal corresponding to an optional advertising program and comprising a sequence triggering the recording in a temporary high-speed memory, in recording the second signal in a temporary high-speed memory on detection of the triggering sequence and in continuously transmitting the first signal to a display circuit. The first signal comprises graphic signaling means to activate the retrieval of video signals stored in the memory.

Advantageously, the second signal is loaded in the memory upon receive-end initialization.

One process advantage of the invention consists of multiplexing a first video signal corresponding to a main program comprising advertising video slots interpolated between video slots, and a second video signal corresponding to an optional advertising program. The second signal comprises a “start” and “end” of sequence delimiter. During signal transmission, the process consists of multiplexing the two signals and recording the second signal in a temporary high-speed memory and continuously transmitting the first signal to a display circuit. It is characterized in that the first signal comprises graphic signaling means for activating the retrieval of the video signals stored in the memory.

Also advantageously, the triggering sequence and the activation signal identifier are correlated. In a variant, the retrieved video signals are substituted for the continuous program corresponding to the first signal stream. In a second variant, the retrieved video signal is superimposed on the continuous program corresponding to the first signal stream.

Preferentially, retrieval activation is activated by a test of the presence of the signaling means and of the activation of a remote control means.

The invention also concerns an interface for program retrieval comprising interactive advertising sequences comprising a high-speed local memory connected to a demultiplexer, high-speed memory content display means and a means of triggering the high-speed memory content display.

This interface may preferably comprise IT communications means allowing the transmission of viewer-related data, such as name and address or the choices made. In a variant, the interface comprises interactive advertising sequences and secure payment means.

The invention will be better understood by means of particular examples of embodiments, which will be described below. Also, the invention applies to the field of satellite television, in broadcasting by cable or by microwave radio system, and by any television broadcasting process.

In a first embodiment example, the advertising is present throughout the day, in the background, either in a particular memory, or in the broadcast signal. It can be accessed at any time of the day by pressing a particular button on the remote control.

Action by the viewer triggers the start of the advertisement. When this happens, the video stream is stopped: a fixed image, in cyclical transmission on the broadcast signal is loaded then displayed on the screen. This promotional image acts as a medium for the display of additional data in text form via an On Screen Display (OSD) of the decoder. This circuit allows text and icons to be displayed and superimposed over a conventional video stream with the possibility of using transparency colors.

At the end of the advertisement, a connection may be established between the subscriber's terminal and a communication server, which may be located with the broadcaster, in a center managed by the advertisers or with any entity involved in processing this data. The communication server is responsible for receiving the calls transmitted by the terminals and sorting the data received. The viewer is still reminded not to forget to connect the terminal to a telephone socket. The subscriber's smart card data is then transmitted by the telephone network or by an data communications network to the communication server, which then builds a database of people wishing to have data. This database may then be subject to specific processing to transmit the desired elements to interest viewers.

A second embodiment concerns advertising synchronized with a conventional video advert. To achieve this synchronization, a sound pulse is used: this pulse is an empty data section comprising a particular identifier. The advertising is set to expect this data section and when it receives it, it proceeds to run it by displaying a visual catch on the screen via the OSD (a transparent blue band, for example) superimposed on the video. In this band, a message is displayed inviting the viewer to press a button on the remote control to receive additional information about a product.

This action triggers the display of a following message, requesting the viewer not to forget to connect the terminal to the telephone socket and to press a button to launch the transaction.

When the button is pressed, a connection is established between the subscriber terminal and the communications server. In the same way as previously mentioned, the subscriber's smart card data is transmitted to the communications server, which constructs a database of people wanting to have more information when the band was displayed.

A third embodiment resumes, at the outset, the principle of the previous advertising where a transparent blue band appears, synchronized with an advert. A message displayed in this band urges the viewer to press a button on the remote control to get additional information about the product.

When the viewer reacts, the video stream is stopped, and possibly the sound stream. A promotional image, in cyclical transmission on the satellite flow is loaded then displayed on the screen. This image acts as background to additional data broadcast in the form of test and icons (animated or fixed), and scripted:

The scripts may be linear; a straightforward data sequence which the viewer can scroll through at the viewer's own pace by means of the remote control. This data may also be scripted in the form of a questionnaire, allowing the viewer to participate in quizzes, to be selected for entertainment shows and the like. These scripts are defined with the advertiser and are not closed in their development.

Each advertisement ends, where necessary, with a transaction with the communications server where the subscriber's smart card data is transmitted as is any data collected during the advertising. In the same way as previously, a database is constituted and transmitted to the advertiser.

What is claimed:

1. A process of remote transmission of a televised program on a single channel comprising:
transmitting a first video signal corresponding to a main program comprising video advertising slots interpolated between video slots, and a second video signal corresponding to an optional advertising program and comprising a sequence triggering recording in a temporary high-speed memory;
recording the second signal in a temporary high-speed memory upon detection of said triggering sequence; and
substantially continuously transmitting the first signal to a display circuit,
wherein the first signal comprises graphic signaling means for activating retrieval of the video signals stored in the memory and the second signal is loaded in the memory upon receive initialization.

2. The process according to claim 1, wherein the triggering sequence and the activation signal identifier are correlated.

3. The process according to claim 1, wherein retrieved video signals are substituted for the continuous program corresponding to the first signal stream.

4. The process according to claim 2, wherein retrieved video signals are substituted for the continuous program corresponding to the first signal stream.

5. The process according to claim 1, wherein at least one retrieved video signal is superimposed on the continuous program corresponding to the first signal stream.

6. The process according to claim 2, wherein at least one retrieved video signal is superimposed on the continuous program corresponding to the first signal stream.

7. The process according to Clam 1, wherein retrieval activation is activated by a test of the presence of the signaling means and of the activation of a remote control means.

8. An interface for program retrieval comprising:
interactive advertising sequences according to claim 1;
a high-speed local memory connected to a demultiplexer;
high-speed memory content display means and means for triggering the high-speed memory content display.

9. The interface according to claim 8, further comprising IT communication means allowing the transmission of viewer-related data.

10. The interface according to claim 9, further comprising secure payment means.
